(19) United States
(12) Patent Application Publication
(10) Pub. No.: US 2022/0143527 A1
(43) Pub. Date: May 12, 2022

(54) METHODS FOR CONTROLLING CRYSTALLIZATION BASED ON TURBIDITY AND SYSTEMS THEREFOR

(71) Applicant: Purdue Research Foundation, West Lafayette, IN (US)

(72) Inventors: Zoltan Nagy, West Lafayette, IN (US); Wei-Lee Wu, West Lafayette, IN (US)

(21) Appl. No.: 17/523,127

(22) Filed: Nov. 10, 2021

Related U.S. Application Data
(60) Provisional application No. 63/112,401, filed on Nov. 11, 2020.

(51) Int. Cl. B01D 9/00; G01N 21/552

(52) U.S. Cl. CPC B01D 9/0054; B01D 9/0059; B01D 2009/0086; G01N 21/553; B01D 9/0063

(57) ABSTRACT

Methods and systems for forming crystallized products from solutions. Such a method includes depositing an input material in a solvent mixture comprising a solvent and an anti-solvent, increasing the temperature of the solvent mixture with the input material therein to an elevated temperature for a period of time sufficient to fully dissolve the input material in the solvent mixture to form a solution of the material, and performing a series of temperature cycles on the solution to produce a crystallized product from the material in the solution. The solution is alternated between heating cycles and cooling cycles based on the turbidity of the solution, and the solution is filtered to remove and collect the crystallized product therefrom.

### CROSS-REFERENCE TO RELATED APPLICATIONS

This application claims the benefit of U.S. Provisional Application No. 63/112,401, filed Nov. 11, 2020, the contents of which are incorporated herein by reference.

### BACKGROUND OF THE INVENTION

The present invention generally relates to industrial crystallization processes. The invention particularly relates to methods for forming a crystallized product from a solution that include controlling crystallization via a series of temperature cycles based on turbidity of the solution.

Crystallization is a process by which a solid forms from another phase, typically a liquid solution or melt. The process involves atoms or molecules arranging into a well-defined, rigid crystal lattice to minimize their energetic state. Although crystallization occurs in nature, crystallization also has broad industrial applications such as for separation and purification processes in the pharmaceutical and chemical industries. For example, crystallization is a key separation process that is used in the agrochemical industry to separate agrochemical actives from impure solutions.

Crystallization occurs when the solubility of a solute in solution is reduced. Common methods for reducing solubility include cooling of the solution, addition of an anti-solvent to the solution, evaporation of the solvent from the solution, and precipitation via a chemical reaction. In general, methods of crystallization include first dissolving a product in the solvent by increasing the temperature of the solvent until all solids of the product are dissolved. The solubility is then reduced with, for example, one of the methods noted previously until the solution becomes supersaturated. As the solubility is reduced, crystals will nucleate and then begin to grow in size. If performed properly, product crystals should form while impurities preferably remain in the solution. The crystallized product may then be removed from the solution and collected.

An inefficient crystallization process can result in various issues such as poor yield, low purity, and long filtration times. To reduce these issues, the use of process analytical technology (PAT) and the availability of various robust in situ sensors have been use to greatly improve the monitoring and control of crystallization processes. Techniques routinely used include focused beam reflectance measurements (FBRM) for in situ analysis of the evolving crystal size distribution, and in-line spectroscopic techniques such as attenuated total reflectance Fourier transformation infrared (ATR-FTIR) and ATR ultraviolet.visible (UV.vis) spectroscopy for solution concentration measurements or for monitoring polymorphic transformation.

Despite the advances noted above, it can be appreciated that there is an ongoing desire for improved methods and systems monitoring and controlling crystallization processes.

### BRIEF DESCRIPTION OF THE INVENTION

The present invention provides systems and methods suitable for producing crystallized products from solutions.

According to one aspect of the invention, a method is provided that includes depositing an input material in a solvent mixture comprising a solvent and an anti-solvent, increasing the temperature of the solvent mixture with the input material therein to an elevated temperature for a period of time sufficient to fully dissolve the input material in the solvent mixture to form a solution of the material, and performing a series of temperature cycles on the solution to produce a crystallized product from the material in the solution. The solution is alternated between heating cycles and cooling cycles based on the turbidity of the solution, and the solution is filtered to remove and collect the crystallized product therefrom.

According to another aspect of the invention, a system is provided that includes a vessel configured to store a liquid solvent mixture comprising a solvent and an anti-solvent, a mixer configured to mix an input material and the solvent mixture, a temperature control device configured to controllably increase and decrease the temperature of a solution comprising the solvent mixture with the input material dissolved therein, a detection device for continuously determining the turbidity of the solution, an operation control device configured to perform a series of temperature cycles on the solution with the temperature control device to produce a crystallized product from the material in the solution that includes alternating between heating cycles and cooling cycles based on the turbidity of the solution, and a filtration device configured to remove and collect the crystallized product from the solution.

Technical effects of methods and systems as described above preferably include the capability of controllably producing high quality crystallized products in an automated manner based on turbidity of the source solution.

Other aspects and advantages of this invention will be appreciated from the following detailed description.

### BRIEF DESCRIPTION OF THE DRAWINGS

FIGS. 1 and 2 contain in-line and off-line images, respectively, acquired from a conventional crystallization process.

FIG. 3 presents an off-line image acquired from a direct nucleation control (DNC) process.

FIGS. 4 and 5 present data obtained during the DNC process.

FIG. 6 presents data obtained during a combination DNC and supersaturation control (SSC) process.

FIGS. 7 and 8 contain images representative of the solution after the DNC process (i.e., the first three cycles) and after the SSC process, respectively.

FIG. 9 contains an off-line image acquired from the combination DNC and SSC process.

FIGS. 10 and 11 contain representative data obtained during a turbidity direct nucleation control (TDNC) process.

FIG. 12 contains an off-line image acquired from the TDNC process.

FIGS. 13 through 16 present data obtained during additional testing of the TDNC process wherein the concentration of the solution was varied.

FIGS. 17 through 19 present data obtained during open loop and scale up testing of the TDNC process.

FIGS. 20 and 21 compare various observations relating to the conventional crystallization process and the open loop TDNC processes.

### DETAILED DESCRIPTION OF THE INVENTION

Disclosed herein are methods for crystallization of a product from a solution to form needle-shaped particles. The methods may use process analytical technology (PAT) tools to acquire data relating to the solution and control the crystallization process. The methods utilize a closed-loop feedback control approach in which temperature cycles are generated and controlled based on turbidity of the solution, that is, the cloudiness or haziness of the solution resulting from suspended solid particles therein. This direct design approach is referred to herein as turbidity direct nucleation control (TDNC). Experimental investigations indicated significant improvement in the overall crystallization-filtration process performance relative to traditional crystallization methods that use linear cooling including improvements to particle shape, particle length, and filtration time.

According to a particular but nonlimiting aspect of the invention, such a method includes dissolving an input material (e.g., agrochemical or pharmaceutical compound) in a solvent mixture comprising a solvent and an anti-solvent to provide a solution of the material. An initial high temperature cycle may be performed to fully dissolve the material. Once the material has been fully dissolved, a series of temperature cycles may be performed to form a crystallized product from the material. The temperature cycles are controlled based on the turbidity of the solution. In some cases, the turbidity may be determined using image-based analysis. For example, during investigations leading to aspects of the present method a probe-based video microscope was used to continuously capture high resolution images of the solution.

During the crystallization process, turbidity within the solution is continuously monitored. The system may be configured to automatically initiate a heating cycle in response to the sensed turbidity reaching or exceeding a predetermined upper threshold, and initiate a cooling cycle in response to the sensed turbidity reaching or falling below a predetermined lower threshold. The solution may be filtered to obtain the crystallized product. In certain cases, the crystallized product may include relatively large and long needle-shaped crystals with a mean crystal size over 90 μm.

Nonlimiting embodiments of the invention will now be described in reference to experimental investigations leading up to the invention. In these investigations, the TDNC approach was tested and compared to a conventional crystallization process, a direct nucleation control (DNC) approach, and a DNC/supersaturation control (SSC) combination approach for a model agrochemical compound.

All of the crystallization processes were performed as batch processes wherein an input material (10 wt. %) was dissolved in a solvent mixture comprising a 1:8 ratio of a solvent and an anti-solvent to form a 500 mL solution.

The crystallization processes were monitored with both in-line and off-line measurement tools. The in-line tools included an attenuated total reflectance (ATR) UV-Vis detector for measuring solute concentration, a focused beam reflectance measurement (FBRM) detector for measuring crystal count and chord length distribution (CLD), and a video microscope probe for crystal image-based analysis. The off-line tools included a high performance liquid chromatography instrument for impurity analysis, an optical microscope for microscopic particle morphology analysis, and a particle characterization tool for number-based size distribution.

Data collected by the measurement tools were transmitted to a computer running crystallization monitoring and control software (CryMoCo). The software enabled the simultaneous monitoring of the data from the measurement tools and the implementation of the temperature profiles in an automated way via a thermoregulator.

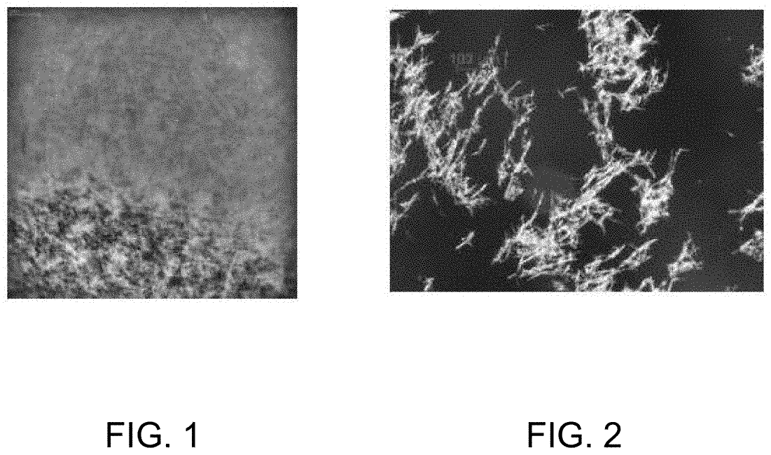

The conventional crystallization process (also referred to as the Original Recipe in the figures) comprised a linear cooling cycle to produce a crystallized product of the input material. FIGS. 1 and 2 present in-line and off-line optical images, respectively, acquired from the conventional crystallization process. The process had an eight-hour process time, required a filtration time of six minutes and 35 seconds, and resulted in needle-shaped particles having a mean particle size of 34.2±2.68 μm with an impurity of 0.02 to 0.05 wt. %.

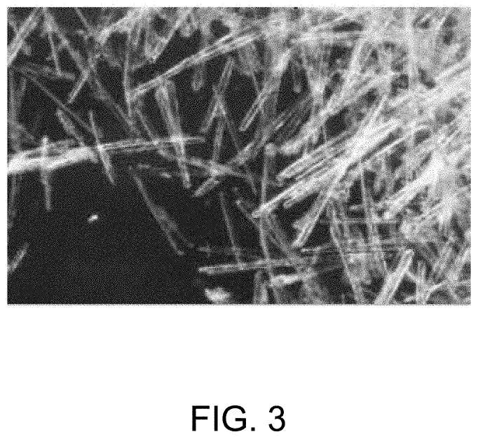

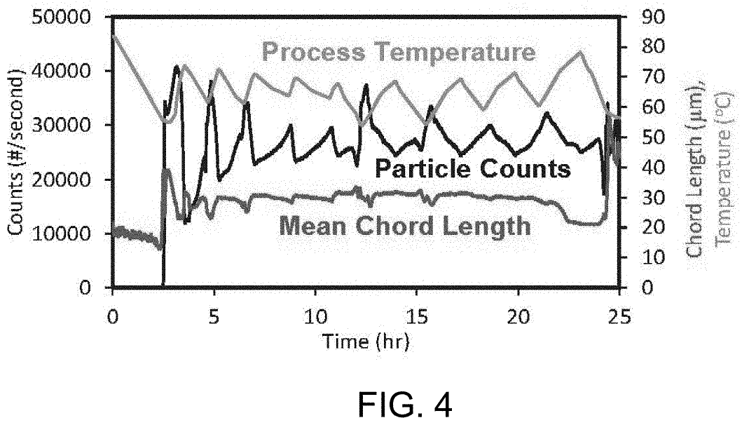

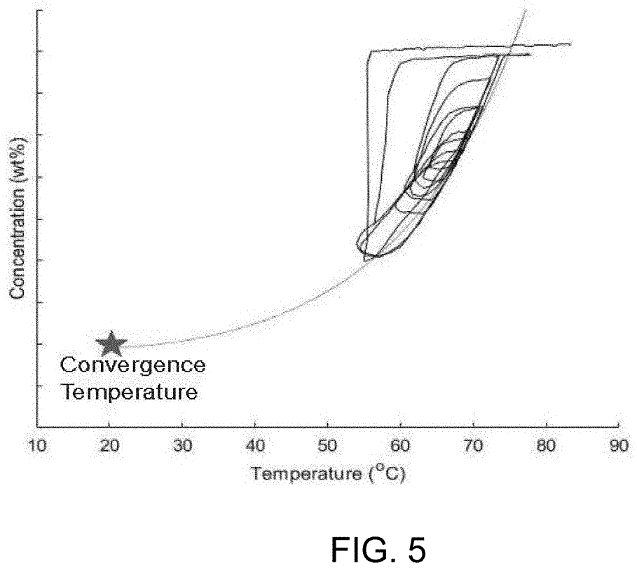

The DNC process comprised a closed-loop feedback control approach wherein the temperature cycles were generated and controlled based on particle measurements obtained with a focused beam reflectance measurement (FBRM) detector. FIG. 3 presents an off-line optical image acquired from the DNC process. The process had a process time of greater than 48 hours, a filtration time could not be determined, and resulted in needle-shaped particles having a mean particle size of 112 μm with an impurity of 0.32 wt. %. The DNC process was observed to have a convergence issue (FIGS. 4 and 5) which made it difficult to discern growth or nucleation and which resulted in increased particle length. Further, the long process time resulted in significant impurity.

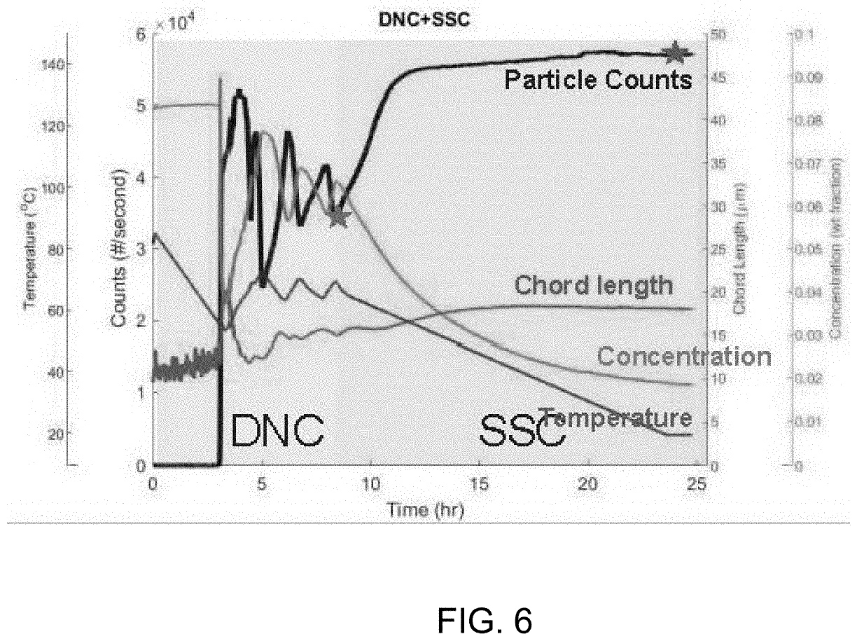

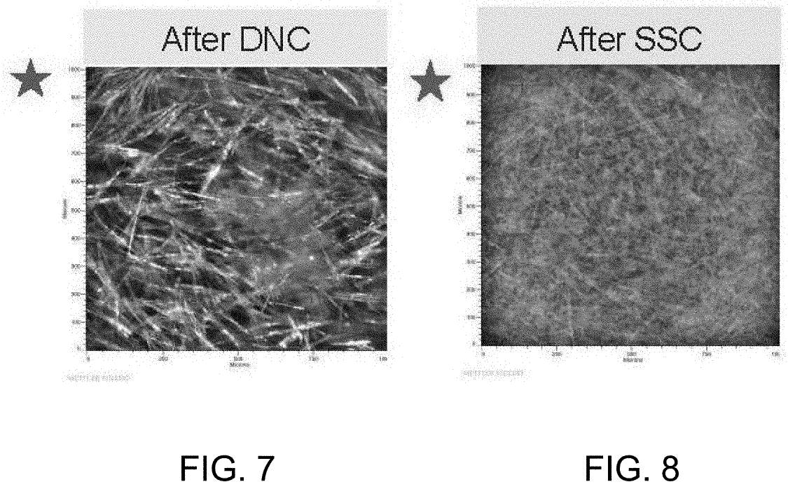

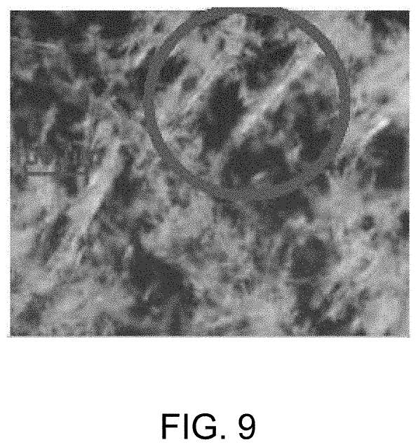

The combination DNC and SSC process comprised using the DNC process described previously for three initial temperature cycles followed by supersaturation control in which concentration was continuously measured with the UV/Vis detector and the temperature was controlled based on the concentration measurements to maintain a constant supersaturation throughout the remainder of the process time (FIG. 6). FIGS. 7 and 8 present optical images representative of the solution after the DNC process (i.e., after the first three cycles) and after the SSC process, respectively. FIG. 9 presents an off-line optical image acquired from the combination DNC and SSC process. The combination DNC and SSC process had a process time of 25 hours, required a filtration time of three minutes and 49 seconds, and resulted in needle-shaped particles having a mean particle size of 60.84 μm with an impurity of 0.05 wt. %. The combination DNC and SSC process was observed to have a secondary nucleation stage in which fine particles were generated during the slow cooling region of the SSC process.

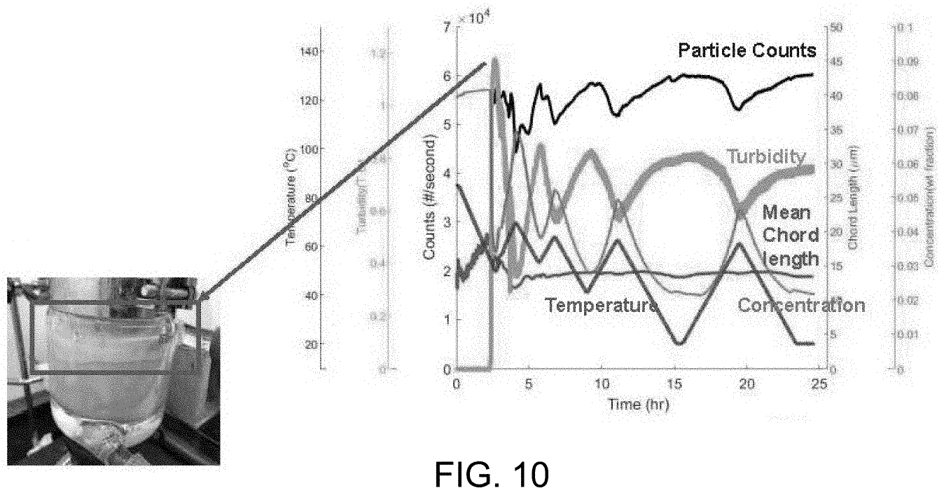

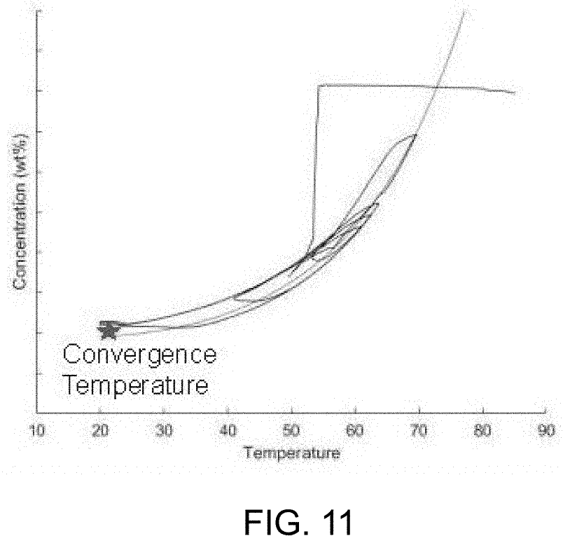

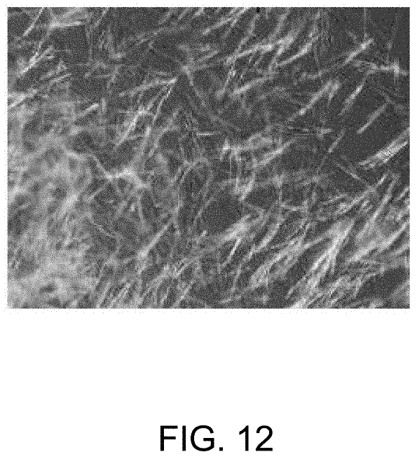

The TDNC process was performed as described above. Feasible turbidity thresholds (i.e., set points) for convergence were determined to be about 0.4 to 0.9. In some cases, preferred turbidity thresholds for convergence were a minimum of 0.6, a mean of 0.7, and a maximum of 0.8 which were observed to promote crystal growth. FIGS. 10 and 11 present representative data obtained during the TDNC process. FIG. 12 presents an off-line optical image acquired from the TDNC process. The process had a process time of 25 hours, required a filtration time of two minutes and 53 seconds, and resulted in needle-shaped particles having a mean particle size of 90.3 μm with an impurity of 0.02 to 0.05 wt. %.

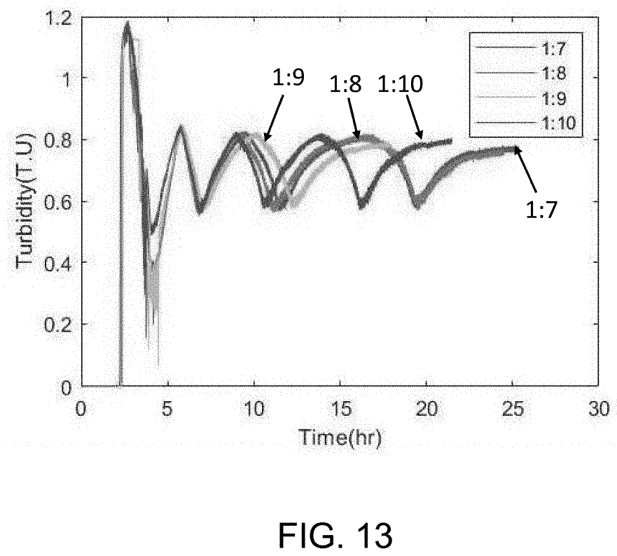

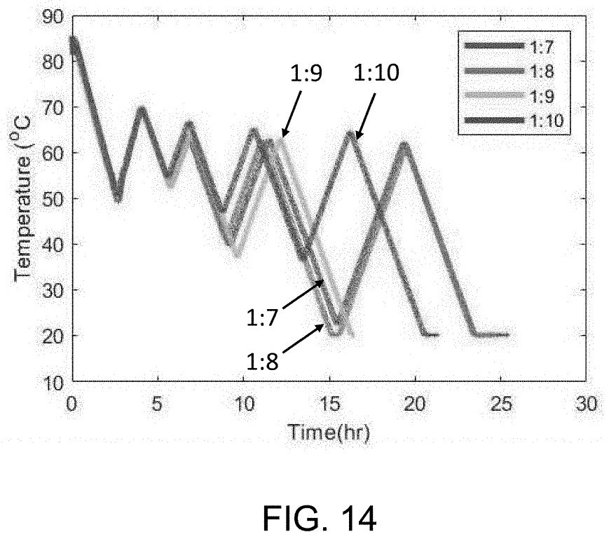

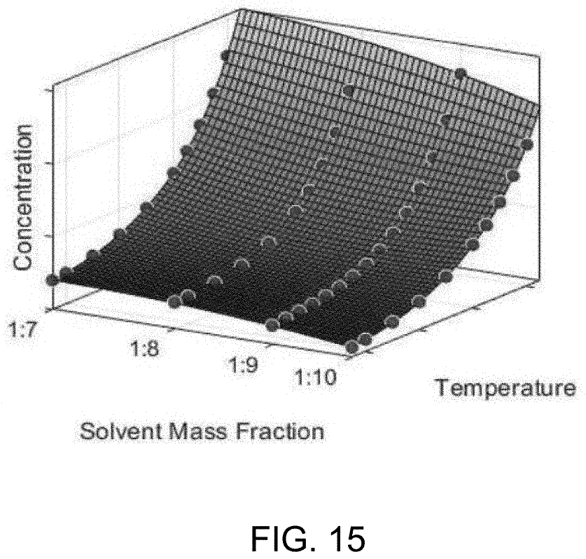

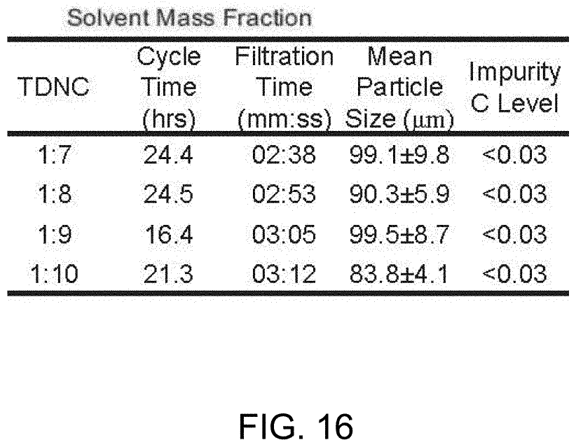

FIGS. 13 through 15 represent additional testing of the TDNC process wherein the concentration of the solution was varied with ratios of 1:7, 1:8, 1:9, and 1:10. The observed cycle times, filtration times, mean particle sizes, and impurity levels resulting from these concentrations are represented in FIG. 16. These results indicate that the solubility of the input material decreases with increasing anti-solvent. Although the convergence time increases with increasing anti-solvent, the convergence time for all concentrations tested was within twenty-four hours.

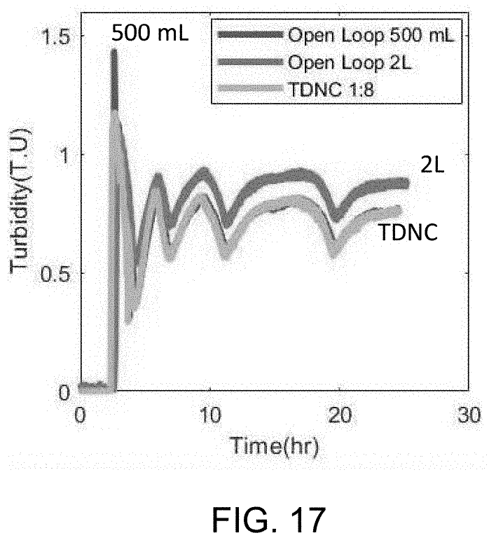

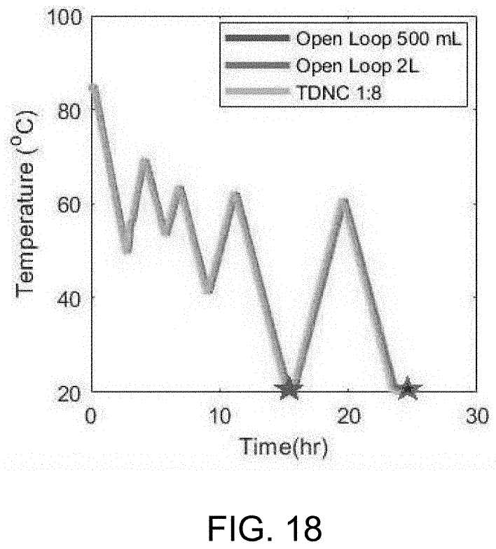

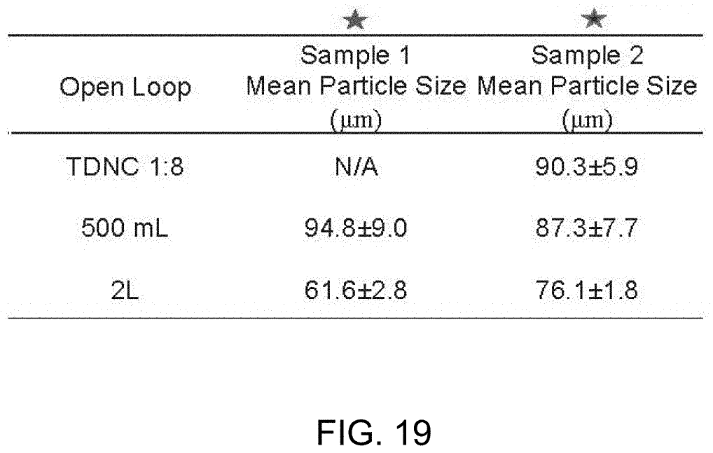

FIGS. 17 through 19 represents open loop and scale up testing of the TDNC process. Samples were obtained and analyzed at the times associated with the stars in FIG. 18. The resulting data of these samples is represented in FIG. 19. This data indicated that the TDNC process may be used in open loop and scaled up systems. Notably, the final cycle was observed to have a significant impact on the scaled-up sample.

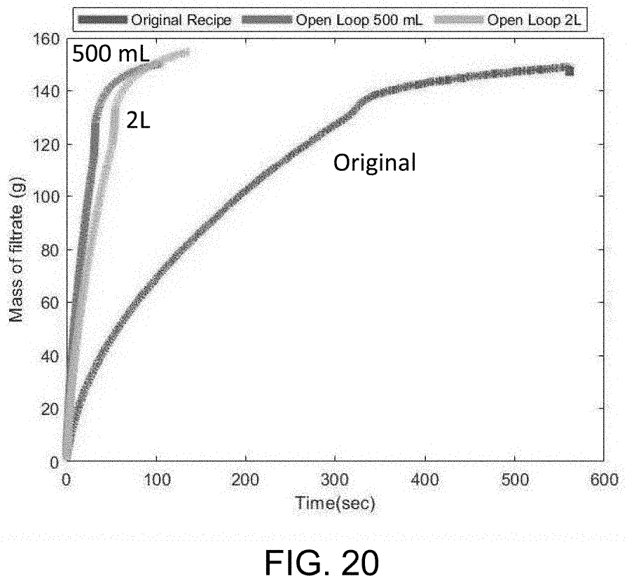

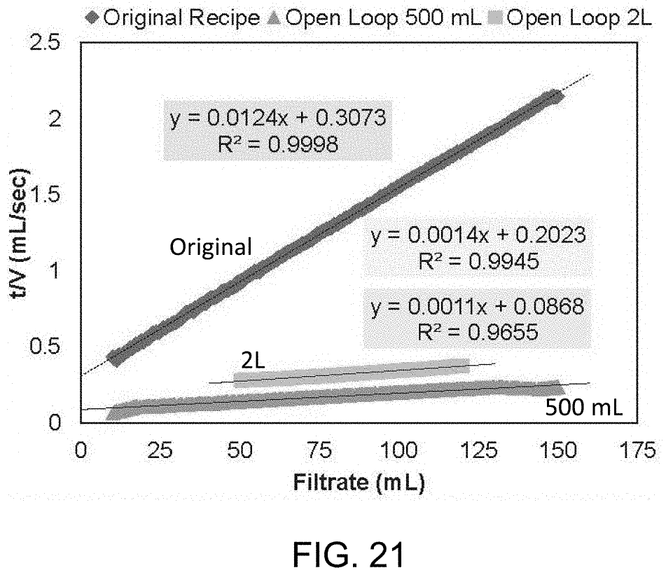

FIGS. 20 and 21 compare various observations relating to the conventional crystallization process and the open loop TDNC processes. The experimental investigations indicated that the TDNC process significantly improved filtration time relative to the other processes tested, including a 2.5 to 4 fold reduction in filtration time relative to the conventional crystallization process, and improved the particle size and reduces impurity levels.

While the invention has been described in terms of specific embodiments, it is apparent that other forms could be adopted by one skilled in the art. For example, the physical configuration of the system could differ from that described, the method may include more or fewer steps, and materials and processes/methods other than those noted could be used. Therefore, the scope of the invention is to be limited only by the following claims.

1. A method comprising:
depositing an input material in a solvent mixture comprising a solvent and an anti-solvent;
increasing the temperature of the solvent mixture with the input material therein to an elevated temperature for a period of time sufficient to fully dissolve the input material in the solvent mixture to form a solution of the material;
performing a series of temperature cycles on the solution to produce a crystallized product from the material in the solution, wherein the solution is alternated between heating cycles and cooling cycles based on the turbidity of the solution; and
filtering the solution to remove and collect the crystallized product therefrom.

2. The method of claim 1, wherein the turbidity of the solution is continuously determined using one or more in-line process analytical technology (PAT) tools.

3. The method of claim 1, wherein the turbidity of the solution is continuously determined using image-based analysis.

4. The method of claim 3, wherein the image-based analysis is performed with a probe-based video microscope used to continuously capture high resolution images of the solution.

5. The method of claim 1, further comprising initiating a heating cycle in response to the turbidity reaching or exceeding a predetermined upper threshold, and initiating a cooling cycle in response to the turbidity reaching or falling below a predetermined lower threshold.

6. The method of claim 1, wherein the series of temperature cycles are generated and controlled automatically based on the turbidity of the solution.

7. The method of claim 1, wherein the crystallized product includes needle-shaped crystals.

8. The method of claim 7, wherein the needle-shaped crystals have a mean crystal size of over 90 μm.

9. The method of claim 1, wherein the series of temperature cycles are performed in a closed loop system.

10. The method of claim 1, wherein the series of temperature cycles are performed in an open loop system.

11. A system comprising:
a vessel configured to store a liquid solvent mixture comprising a solvent and an anti-solvent;
a mixer configured to mix an input material and the solvent mixture;
a temperature control device configured to controllably increase and decrease the temperature of a solution comprising the solvent mixture with the input material dissolved therein;
a detection device for continuously determining the turbidity of the solution;
an operation control device configured to perform a series of temperature cycles on the solution with the temperature control device to produce a crystallized product from the material in the solution that includes alternating between heating cycles and cooling cycles based on the turbidity of the solution; and
a filtration device configured to remove and collect the crystallized product from the solution.

12. The system of claim 11, wherein the detection device for determining the turbidity of the solution includes one or more in-line process analytical technology (PAT) tools.

13. The system of claim 11, wherein the detection device is configured for performing image-based analysis.

14. The system of claim 13, wherein the detection device includes a probe-based video microscope configured to continuously capture high resolution images of the solution.

15. The system of claim 11, wherein the operation control device is configured to automatically initiate a heating cycle in response to the turbidity reaching or exceeding a predetermined upper threshold, and initiate a cooling cycle in response to the turbidity reaching or falling below a predetermined lower threshold.
